(19) United States
(12) Patent Application Publication
(10) Pub. No.: US 2011/0173375 A1
(43) Pub. Date: Jul. 14, 2011

(54) METHOD FOR ENHANCING FILE SYSTEM PERFORMANCE, AND ASSOCIATED MEMORY DEVICE AND CONTROLLER THEREOF

(76) Inventor: XIANGRONG LI, Beijing (CN)

(21) Appl. No.: 12/699,885

(22) Filed: Feb. 4, 2010

(30) Foreign Application Priority Data
Jan. 8, 2010 (TW) 099100369

(51) Int. Cl. G06F 12/00; G06F 17/00; G06F 12/02

(52) U.S. Cl. 711/103; 707/609; 707/824; 707/687; 707/E17.005; 711/E12.001; 711/E12.008

(57) ABSTRACT

A method for enhancing file system performance includes: in a situation where operations of visiting a file system of a memory device according to a plurality of file names are performed, regarding each of the file names, extracting a characteristic value and full file name location information from file information that is first read, and temporarily storing the characteristic value and the full file name location information; and when visiting the file system according to a target file name, checking whether any of temporarily stored characteristic values matches the target file name, and determining accordingly whether to perform a file system operation corresponding to the target file name. An associated memory device and the controller thereof are further provided.

### BACKGROUND OF THE INVENTION

1. Field of the Invention

The present invention relates to access to a file system of a memory device, and more particularly, to a method for enhancing file system performance, and to an associated memory device and a controller thereof.

2. Description of the Prior Art

As technologies of Flash memories progress in recent years, many kinds of portable memory devices, such as memory cards respectively complying with SD/MMC, CF, MS, and XD standards, are widely implemented in various applications. Therefore, the control of access to Flash memories in these portable memory devices has become an important issue.

Taking NAND Flash memories as an example, they can mainly be divided into two types, i.e. Single Level Cell (SLC) Flash memories and Multiple Level Cell (MLC) Flash memories. Each transistor that is considered a memory cell in SLC Flash memories only has two charge levels that respectively represent a logical value 0 and a logical value 1. In addition, the storage capability of each transistor that is considered a memory cell in MLC Flash memories can be fully utilized. More specifically, the voltage for driving memory cells in the MLC Flash memories is typically higher than that in the SLC Flash memories, and different voltage levels can be applied to the memory cells in the MLC Flash memories in order to record information of two bits (e.g. binary values 00, 01, 11, or 10) in a transistor that is considered a memory cell. Theoretically, the storage density of the MLC Flash memories may reach twice the storage density of the SLC Flash memories, which is considered good news for NAND Flash memory manufacturers who encountered a bottleneck of NAND Flash technologies.

As MLC Flash memories are cheaper than SLC Flash memories, and are capable of providing higher capacity than SLC Flash memories while the space is limited, MLC Flash memories have been a main stream for implementation of most portable memory devices on the market. However, various problems of the MLC Flash memories have arisen due to their unstable characteristics. Although there are some solutions proposed by the related art in response to these problems, it seems unlikely that the related art gives consideration to both operation performance and system resource management. As a result, no matter which solution is chosen, a corresponding side effect typically exists.

In addition, it seems that the related art does not manage file systems of memory devices well since many preliminary reading operations are typically required for improving access to the file systems. However, even with plenty of preliminary reading operations, it can not be guaranteed that useful data is certainly to be read, and therefore, the related art wastes time and also wastes buffering space. Thus, a novel method is required for enhancing the control of data access of a Flash memory in a memory device, in order to give consideration to both operation performance and system resource management.

### SUMMARY OF THE INVENTION

It is therefore an objective of the claimed invention to provide a method for enhancing file system performance, and to provide an associated memory device and a controller thereof, in order to solve the above-mentioned problems.

According to a preferred embodiment of the claimed invention, a method for enhancing file system performance comprises: in a situation where operations of visiting a file system of a memory device according to a plurality of file names are performed, with regard to each of the file names, extracting a characteristic value and full file name location information from file information that is first read, and temporarily storing the characteristic value and the full file name location information; and when visiting the file system according to a target file name, checking whether any of temporarily stored characteristic values matches the target file name, and determining accordingly whether to perform a file system operation corresponding to the target file name.

While the method mentioned above is disclosed, an associated memory device is further provided. The memory device comprises: a Flash memory comprising a plurality of blocks; and a controller arranged to access the Flash memory and manage the plurality of blocks, and to enhance file system performance. In addition, in a situation where operations of visiting a file system of the memory device according to a plurality of file names are performed, with regard to each of the file names, the controller extracts a characteristic value and full file name location information from file information that is first read, and temporarily stores the characteristic value and the full file name location information. Additionally, when visiting the file system according to a target file name, the controller checks whether any of temporarily stored characteristic values matches the target file name, and determines accordingly whether to perform a file system operation corresponding to the target file name.

While the method mentioned above is disclosed, a controller of a memory device is further provided, wherein the controller is utilized for accessing a Flash memory of the memory device, and the Flash memory comprises a plurality of blocks. The controller comprises: a read only memory (ROM) arranged to store a program code; and a microprocessor arranged to execute the program code to control the access to the Flash memory and manage the plurality of blocks, wherein the controller that executes the program code by utilizing the microprocessor is further arranged to enhance file system performance. In addition, in a situation where operations of visiting a file system of the memory device according to a plurality of file names are performed, with regard to each of the file names, the controller that executes the program code by utilizing the microprocessor extracts a characteristic value and full file name location information from file information that is first read, and temporarily stores the characteristic value and the full file name location information. Additionally, when visiting the file system according to a target file name, the controller that executes the program code by utilizing the microprocessor checks whether any of temporarily stored characteristic values matches the target file name, and determines accordingly whether to perform a file system operation corresponding to the target file name.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a memory device according to a first embodiment of the present invention.

FIG. 2 is a flowchart of a method for enhancing file system performance according to an embodiment of the present invention.

FIGS. 3-4 illustrate diagrams of some implementation details of the method shown in FIG. 2 according to an embodiment of the present invention.

### DETAILED DESCRIPTION

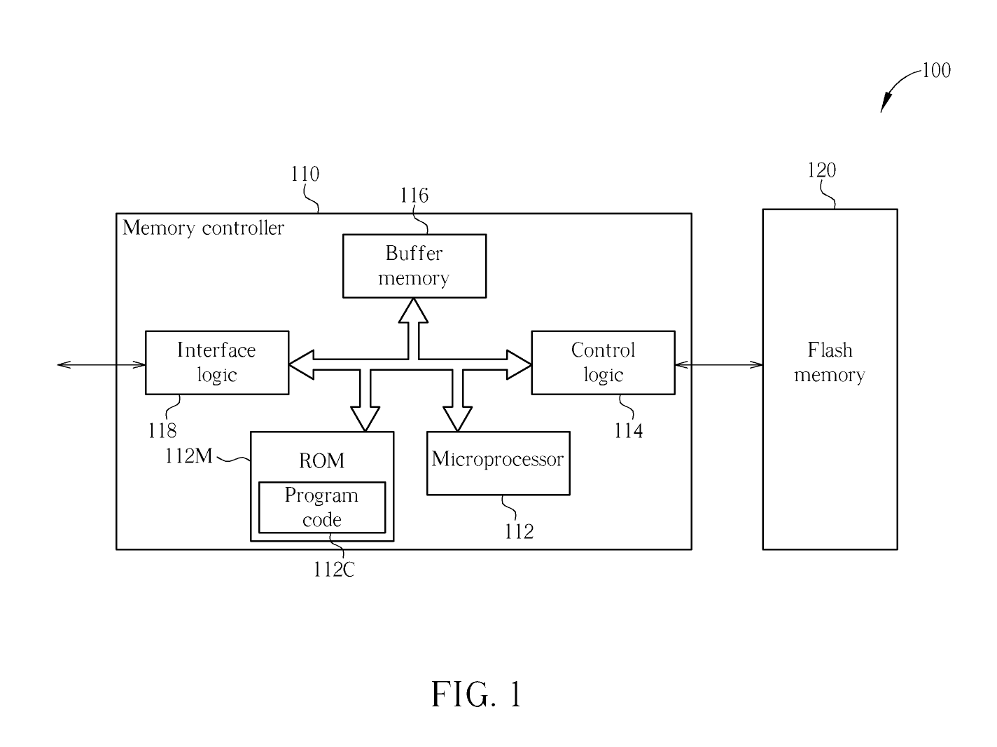

Please refer to FIG. 1, which illustrates a diagram of a memory device 100 according to a first embodiment of the present invention. In particular, the memory device 100 of this embodiment is a portable memory device, such as a memory card complying with SD/MMC, CF, MS, or XD standards. The memory device 100 comprises a Flash memory 120, and further comprises a controller arranged to access the Flash memory 120, where the aforementioned controller of this embodiment is a memory controller 110. According to this embodiment, the memory controller 110 comprises a microprocessor 112, a read only memory (ROM) 112M, a control logic 114, a buffer memory 116, and an interface logic 118. In addition, the ROM 112M is arranged to store a program code 112C, and the microprocessor 112 is arranged to execute the program code 112C to control the access to the Flash memory 120. Please note that, according to different variations of this embodiment, the program code 112C can be stored in the buffer memory 116 or any other memory.

Typically, the Flash memory 120 comprises a plurality of blocks, and the controller (e.g. the memory controller 110 that executes the program code 112C by utilizing the microprocessor 112) performs data erasure operations on the Flash memory 120 by erasing in units of blocks. In addition, a block can be utilized for recording a specific amount of pages, where the controller mentioned above performs data writing operations on the Flash memory 120 by writing/programming in units of pages.

In practice, the memory controller 110 that executes the program code 112C by utilizing the microprocessor 112 is capable of performing various control operations by utilizing the internal components within the memory controller 110. For example, the memory controller 110 utilizes the control logic 114 to control access to the Flash memory 120 (e.g. operations of accessing at least one block or at least one page), utilizes the buffer memory 116 to perform buffering operations for the memory controller 110, and utilizes the interface logic 118 to communicate with a host device.

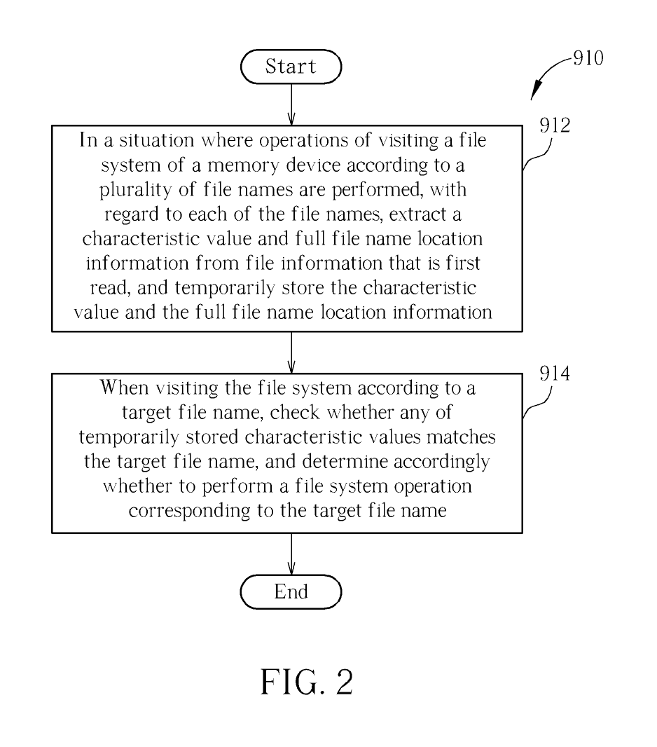

According to this embodiment, in addition to accessing the Flash memory 120, the controller is capable of enhancing file system performance of the memory device 100. More specifically, in a situation where operations of visiting a file system of the memory device 100 according to a plurality of file names (e.g. exploring the contents of the directories of the file system, or accessing files of the file system) are performed, with regard to each of the file names, the controller extracts a characteristic value and full file name location information from file information that is first read, and temporarily stores the characteristic value and the full file name location information. In addition, when visiting the file system according to a target file name, the controller checks whether any of temporarily stored characteristic values matches the target file name, and determines accordingly whether to perform a file system operation corresponding to the target file name. Related details are described by referring to FIG. 2.

FIG. 2 is a flowchart of a method 910 for enhancing file system performance according to an embodiment of the present invention. The method can be applied to the memory device 100 shown in FIG. 1, and more particularly, to the controller mentioned above (e.g. the memory controller 110 that executes the program code 112C by utilizing the microprocessor 112). In addition, the method can be implemented by utilizing the memory device 100 shown in FIG. 1, and more particularly, by utilizing the controller mentioned above. The method 910 is described as follows.

In Step 912, in a situation where operations of visiting a file system of the memory device 100 according to a plurality of file names are performed, with regard to each of the file names, the aforementioned controller (e.g. the memory controller 110 that executes the program code 112C by utilizing the microprocessor 112) extracts a characteristic value and full file name location information from file information that is first read, and temporarily stores the characteristic value and the full file name location information. For example, the characteristic value may comprise at least one portion (e.g. one or more bytes) of the file name represented by the characteristic value and/or the checksum of the file name. In another example, the file name represented by the characteristic value comprise a long file name (which comprises a main file name of more than 8 bytes and an extended file name of 3 bytes) and a short file name (which comprises a main file name of no more than 8 bytes and an extended file name of 3 bytes), and the characteristic value may comprise at least one portion (e.g. one or more bytes) of the long file name, the checksum of the long file name, at least one portion (e.g. one or more bytes) of the short file name, and/or the checksum of the short file name.

In Step 914, when visiting the file system according to a target file name, the controller checks whether any of temporarily stored characteristic values matches the target file name, and determines accordingly whether to perform a file system operation corresponding to the target file name. More particularly, when receiving a file system operation command sent from the host device regarding the target file name, the controller can utilize the temporarily stored characteristic values to rapidly perform comparing operations, and therefore can rapidly check whether the file system operation represented by the file system operation command violates some predetermined rules or not, in order to determine whether to perform the file system operation. For example, in a situation where the file system operation command instructs the memory device 100 to create a file, the controller can perform this operation only when the target file name is different from any of the existing file names in the associated directory. In another example, in a situation where the file system operation command instructs the memory device 100 to open/delete the file represented by the target file name, the controller can perform this operation only when the target file name is the same as a certain file name in the associated directory. By utilizing the temporarily stored characteristic values, the controller can rapidly determine whether to perform the file system operation corresponding to the target file name. Therefore, the present invention method and the associated memory device and the controller thereof can provide extremely high performance.

According to this embodiment, in a situation where a specific characteristic value of the temporarily stored characteristic values matches the target file name, the controller reads a corresponding file name indicated by the full file name location information corresponding to the specific characteristic value, and checks whether the target file name and the corresponding file name are the same. In a situation where the target file name and the corresponding file name are the same, the controller temporarily stops checking whether any of the temporarily stored characteristic values matches the target file name. As a result, by utilizing the temporarily stored characteristic values, the controller can rapidly determine whether to perform the file system operation corresponding to the target file name. As the controller can utilize the temporarily stored characteristic values to rapidly perform comparing operations, rather than reading each file name entry within the directory, the present invention can enhance the file system performance and save time.

Please note that, in a situation where the target file name and the corresponding file name are not the same, the controller checks whether any other characteristic value of the temporarily stored characteristic values matches the target file name. In a situation where none of the temporarily stored characteristic values matches the target file name, the controller temporarily stops checking whether any of the temporarily stored characteristic values matches the target file name. Thus, the controller completes the comparing operations of all of the characteristic values that have been temporarily stored. In a situation where none of the temporarily stored characteristic values matches the target file name and, within at least an associated directory, there is still at least one file name that has no corresponding characteristic value, the controller checks whether the target file name is the same as any of the at least one file name, in order to complete the comparing operations of all of the file name(s) in the directory and determine accordingly whether to perform the file system operation corresponding to the target file name. More particularly, with regard to each of the at least one file name, the controller extracts a corresponding characteristic value and corresponding full file name location information from file information that is first read, and temporarily stores the corresponding characteristic value and the corresponding full file name location information, in order to further expand the database of the temporarily stored characteristic values. As a result, when the same target file name is encountered the next time, the controller can operate more rapidly.

According to a special case of this embodiment, the controller can first extract the characteristic value of the target file name, and then compare the characteristic value of the target file name with the temporarily stored characteristic values to determine whether the characteristic value of the target file name is the same as any of the temporarily stored characteristic values, in order to complete the operation of Step 914. For example, in a situation where the characteristic value comprises at least one portion of the file name represented by the characteristic value and the checksum of the file name, extracting the characteristic value of the target file name in advance can enhance the performance of the controller. This is for illustrative purposes only, and is not meant to be a limitation of the present invention. According to some variations of this embodiment, in a situation where the characteristic value mentioned in Step 912 only includes at least one portion of the file name represented by the characteristic value, the controller can perform the operation of Step 914, having no need to extract the characteristic value of the target file name.

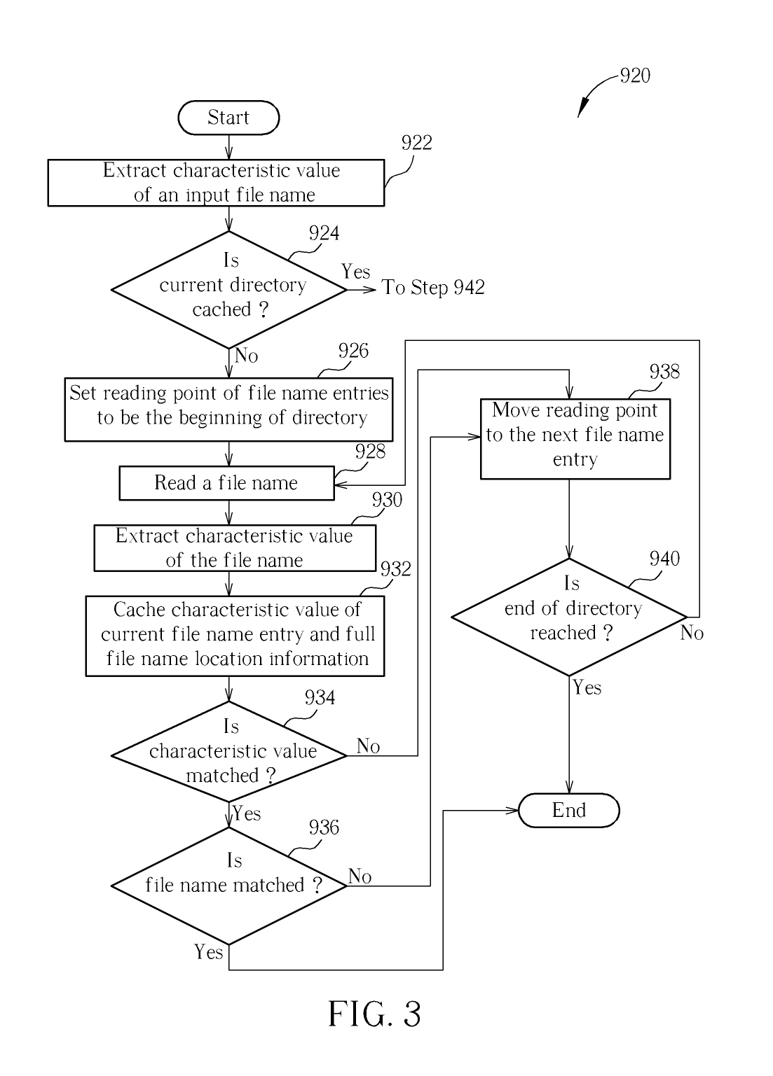

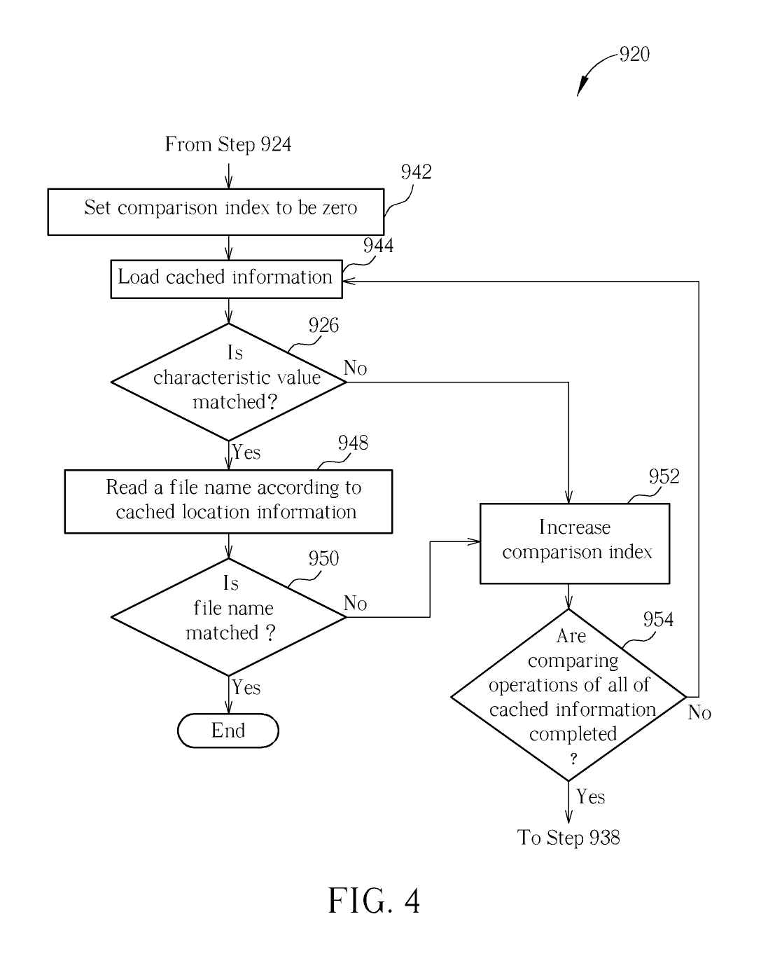

FIGS. 3-4 illustrate diagrams of some implementation details of the method 910 shown in FIG. 2 according to an embodiment of the present invention, where this embodiment is a variation of the embodiment shown in FIG. 2. When receiving a file system operation command sent from the host device regarding the target file name, the aforementioned controller (e.g. the memory controller 110 that executes the program code 112C by utilizing the microprocessor 112) can execute the working flow 920 shown in FIGS. 3-4, in order to determine whether to perform the file system operation corresponding to the target file name. The working flow 920 is described as follows:

Referring to FIG. 3, in Step 922, the controller extracts the characteristic value of an input file name. Here, the input file name represents the target file name, and more particularly, the target file name that the host device inputs into the controller.

In Step 924, the controller checks whether the current directory is cached. When the current directory is cached, Step 942 is entered; otherwise, Step 926 is entered.

In Step 926, the controller sets the reading point of the file name entries to be the beginning of the directory. Here, each entry of the directory comprises the respective file name and the associated information thereof, so the entries of the directory can be referred to as file name entries, where the controller can read them one by one.

In Step 928, the controller reads a file name.

In Step 930, the controller extracts the characteristic value of the file name (i.e. the file name read in Step 928).

In Step 932, the controller caches the characteristic value of the current file name entry and the full file name location information.

In Step 934, the controller checks whether the characteristic value is matched. More specifically, the controller checks whether the characteristic value of the file name matches the characteristic value of the input file name. When the characteristic value is matched, Step 936 is entered; otherwise, Step 938 is entered.

In Step 936, the controller checks whether the file name is matched. More specifically, the controller checks whether the file name matches the input file name. When the file name is matched, the working flow 920 is ended; otherwise, Step 938 is entered.

In Step 938, the controller moves the reading point to the next file name entry.

In Step 940, the controller checks whether the end of the directory is reached. When the end of the directory is reached, the working flow 920 is ended; otherwise, Step 928 is re-entered.

Referring to FIG. 4, in Step 942, the controller sets a comparison index to be zero, where the comparison index is the index required for performing the operations shown in FIG. 4, and more particularly, those starting from Step 944.

In Step 944, the controller loads cached information, i.e. the information of the current directory mentioned in Step 924, and more particularly, the partial information corresponding to the comparison index.

In Step 946, the controller checks whether the characteristic value is matched. More specifically, the controller checks whether the characteristic value within the partial information matches the characteristic value of the input file name. When the characteristic value is matched, Step 948 is entered; otherwise, Step 952 is entered.

In Step 948, the controller reads a file name according to the cached location information. More particularly, the controller reads the corresponding file name indicated by the full file name location information within the partial information.

In Step 950, the controller checks whether the file name is matched. More specifically, the controller checks whether the file name read in Step 948 matches the input file name. When the file name is matched, the working flow 920 is ended; otherwise, Step 952 is entered.

In Step 952, the controller increases the comparison index.

In Step 954, the controller checks whether the comparing operations of all of the cached information are completed. When the comparing operations of all of the cached information are completed, Step 938 is entered; otherwise, Step 944 is re-entered.

Please note that, in Step 942, the controller sets the comparison index to be zero. This is for illustrative purposes only, and is not meant to be a limitation of the present invention. According to some variations of this embodiment, in a situation where the input file name mentioned in Step 922 (i.e. the target file name) represents the file name entry selected by the user during exploring within the file system, in Step 942, the controller can set the comparison index to be an index representing the file name entry selected by the user.

It is an advantage of the present invention that, by utilizing the temporarily stored characteristic values, the controller can rapidly determine whether to perform the file system operation corresponding to the target file name. Therefore, the present invention method and the associated memory device and the controller thereof can provide extremely high performance. In addition, by utilizing the present invention, the related art problems such as the waste of time and the waste of buffering space due to too many preliminary reading operations will never occur. Therefore, the present invention can give consideration to both operation performance and system resource management.

Those skilled in the art will readily observe that numerous modifications and alterations of the device and method may be made while retaining the teachings of the invention.

What is claimed is:

1. A method for enhancing file system performance, the method comprising:
in a situation where operations of visiting a file system of a memory device according to a plurality of file names are performed, with regard to each of the file names, extracting a characteristic value and full file name location information from file information that is first read, and temporarily storing the characteristic value and the full file name location information; and
when visiting the file system according to a target file name, checking whether any of temporarily stored characteristic values matches the target file name, and determining accordingly whether to perform a file system operation corresponding to the target file name.

2. The method of claim 1, wherein the step of checking whether any of the temporarily stored characteristic values matches the target file name and determining accordingly whether to perform the file system operation corresponding to the target file name further comprises:
in a situation where a specific characteristic value of the temporarily stored characteristic values matches the target file name, reading a corresponding file name indicated by full file name location information corresponding to the specific characteristic value, and checking whether the target file name and the corresponding file name are the same.

3. The method of claim 2, wherein the step of checking whether any of the temporarily stored characteristic values matches the target file name and determining accordingly whether to perform the file system operation corresponding to the target file name further comprises:
in a situation where the target file name and the corresponding file name are not the same, checking whether any other characteristic value of the temporarily stored characteristic values matches the target file name.

4. The method of claim 3, wherein the step of checking whether any of the temporarily stored characteristic values matches the target file name and determining accordingly whether to perform the file system operation corresponding to the target file name further comprises:
in a situation where none of the temporarily stored characteristic values matches the target file name, temporarily stopping checking whether any of the temporarily stored characteristic values matches the target file name.

5. The method of claim 2, wherein the step of checking whether any of the temporarily stored characteristic values matches the target file name and determining accordingly whether to perform the file system operation corresponding to the target file name further comprises:
in a situation where the target file name and the corresponding file name are the same, temporarily stopping checking whether any of the temporarily stored characteristic values matches the target file name.

6. The method of claim 1, further comprising:
in a situation where none of the temporarily stored characteristic values matches the target file name and, within at least an associated directory, there is still at least one file name that has no corresponding characteristic value, checking whether the target file name is the same as any of the at least one file name.

7. The method of claim 6, further comprising:
with regard to each of the at least one file name, extracting a corresponding characteristic value and corresponding full file name location information from file information that is first read, and temporarily storing the corresponding characteristic value and the corresponding full file name location information.

8. A memory device, comprising:
a Flash memory comprising a plurality of blocks; and
a controller arranged to access the Flash memory and manage the plurality of blocks, and to enhance file system performance, wherein in a situation where operations of visiting a file system of the memory device according to a plurality of file names are performed, with regard to each of the file names, the controller extracts a characteristic value and full file name location information from file information that is first read, and temporarily stores the characteristic value and the full file name location information;
wherein when visiting the file system according to a target file name, the controller checks whether any of temporarily stored characteristic values matches the target file name, and determines accordingly whether to perform a file system operation corresponding to the target file name.

9. The memory device of claim 8, wherein in a situation where a specific characteristic value of the temporarily stored characteristic values matches the target file name, the controller reads a corresponding file name indicated by full file name location information corresponding to the specific characteristic value, and checks whether the target file name and the corresponding file name are the same.

10. The memory device of claim 9, wherein in a situation where the target file name and the corresponding file name are not the same, the controller checks whether any other characteristic value of the temporarily stored characteristic values matches the target file name.

11. The memory device of claim 10, wherein in a situation where none of the temporarily stored characteristic values matches the target file name, the controller temporarily stops checking whether any of the temporarily stored characteristic values matches the target file name.

12. The memory device of claim 9, wherein in a situation where the target file name and the corresponding file name are the same, the controller temporarily stops checking whether any of the temporarily stored characteristic values matches the target file name.

13. The memory device of claim 8, wherein in a situation where none of the temporarily stored characteristic values matches the target file name and, within at least an associated directory, there is still at least one file name that has no corresponding characteristic value, the controller checks whether the target file name is the same as any of the at least one file name.

14. The memory device of claim 13, wherein with regard to each of the at least one file name, the controller extracts a corresponding characteristic value and corresponding full file name location information from file information that is first read, and temporarily stores the corresponding characteristic value and the corresponding full file name location information.

15. A controller of a memory device, the controller being utilized for accessing a Flash memory of the memory device, the Flash memory comprising a plurality of blocks, the controller comprising:
a read only memory (ROM) arranged to store a program code; and
a microprocessor arranged to execute the program code to control the access to the Flash memory and manage the plurality of blocks, wherein the controller that executes the program code by utilizing the microprocessor is further arranged to enhance file system performance, and in a situation where operations of visiting a file system of the memory device according to a plurality of file names are performed, with regard to each of the file names, the controller that executes the program code by utilizing the microprocessor extracts a characteristic value and full file name location information from file information that is first read, and temporarily stores the characteristic value and the full file name location information;
wherein when visiting the file system according to a target file name, the controller that executes the program code by utilizing the microprocessor checks whether any of temporarily stored characteristic values matches the target file name, and determines accordingly whether to perform a file system operation corresponding to the target file name.

16. The controller of claim 15, wherein in a situation where a specific characteristic value of the temporarily stored characteristic values matches the target file name, the controller that executes the program code by utilizing the microprocessor reads a corresponding file name indicated by full file name location information corresponding to the specific characteristic value, and checks whether the target file name and the corresponding file name are the same.

17. The controller of claim 16, wherein in a situation where the target file name and the corresponding file name are not the same, the controller that executes the program code by utilizing the microprocessor checks whether any other characteristic value of the temporarily stored characteristic values matches the target file name.

18. The controller of claim 17, wherein in a situation where none of the temporarily stored characteristic values matches the target file name, the controller that executes the program code by utilizing the microprocessor temporarily stops checking whether any of the temporarily stored characteristic values matches the target file name.

19. The controller of claim 16, wherein in a situation where the target file name and the corresponding file name are the same, the controller that executes the program code by utilizing the microprocessor temporarily stops checking whether any of the temporarily stored characteristic values matches the target file name.

20. The controller of claim 15, wherein in a situation where none of the temporarily stored characteristic values matches the target file name and, within at least an associated directory, there is still at least one file name that has no corresponding characteristic value, the controller that executes the program code by utilizing the microprocessor checks whether the target file name is the same as any of the at least one file name.

21. The controller of claim 20, wherein with regard to each of the at least one file name, the controller that executes the program code by utilizing the microprocessor extracts a corresponding characteristic value and corresponding full file name location information from file information that is first read, and temporarily stores the corresponding characteristic value and the corresponding full file name location information.
